(19) United States
(12) Patent Application Publication
(10) Pub. No.: US 2006/0047647 A1
(43) Pub. Date: Mar. 2, 2006

(54) Method and apparatus for retrieving data

(75) Inventors: Hideo Kuboyama, Yokohama-shi (JP); Hiroki Yamamoto, Yokohama-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/202,493

(22) Filed: Aug. 12, 2005

(30) Foreign Application Priority Data
Aug. 27, 2004 (JP) 2004-249014

(51) Int. Cl. G06F 17/30

(52) U.S. Cl. 707/4

(57) ABSTRACT

A method for retrieving data from a database storing a plurality of retrieval data components including associated annotation data segments including subword strings obtained by speech recognition includes a receiving step for receiving a retrieval key, an acquiring step for acquiring a result by retrieving retrieval data components based on a degree of correlation between the retrieval key received by the receiving step and each of the annotation data segments, a selecting step for selecting a data segment from the result acquired by the acquiring step in accordance with an instruction from a user, and a registering step for registering the retrieval key received by the receiving step in an annotation data segment associated with the selected data segment. Therefore, a high data-retrieval accuracy is realized even when retrieval data includes an associated annotation created by speech recognition together with recognition errors.

### BACKGROUND OF THE INVENTION

1. Field of the Invention

The present invention relates to a method and apparatus for retrieving data.

2. Description of the Related Art

Digital images captured by portable imaging devices, such as digital cameras, can be managed with personal computers (PCs) or server computers. For example, captured images can be organized in folders on PCs or servers, and a specified image among the captured images can be printed out or inserted in a greeting card. For management on servers, opening some images to other users is possible.

To conduct these management operations, it is necessary to find an image that a user desires. If the number of images to be retrieved is small, a user can find a target image by viewing the list of thumbnails of the images. However, if hundreds of images must be retrieved, or if a group of images to be retrieved is partitioned and stored in multiple folders, finding the target image by viewing is difficult.

Sound annotations added to images on imaging devices are often used in retrieving. For example, when a user captures an image of a mountain and says “Hakone no Yama” to the image, this sound data and image data are stored as a set in an imaging device. The sound data is then speech-recognized in the imaging device or a PC to which the image is uploaded, and converted to text information indicating “hakonenoyama”. After annotation data is converted to text information, common text retrieving techniques are applicable. Therefore, the image can be retrieved by a word, such as “Yama”, “Hakone”, or the like.

Another conventional technique relating to the present invention is disclosed in Japanese Patent Laid-Open No. 2-027479 describing a technique for registering a retrieval key input by a user. According to this technique, the retrieval key input by the user is registered as an operation expression of an existing keyword in a system by the use of synonyms and the like.

In the case of retrieving performed after sound annotations are converted by speech recognition, recognition errors are inescapable under present circumstances. A high proportion of recognition errors leads to poor correlation in matching even if a retrieval key is correctly entered, thus resulting in unsatisfactory retrieval. In other words, no matter how the retrieval key is entered, because of poor speech recognition, desired image data is not retrieved at a high ranking.

Accordingly, it is necessary to introduce a technology capable of realizing a high data-retrieval accuracy even when retrieval data includes an associated annotation created by speech recognition together with recognition errors.

### SUMMARY OF THE INVENTION

To solve the above problems, according to one aspect of the present invention, a method for retrieving data from a database storing a plurality of retrieval data components including associated annotation data segments, each annotation data segment including at least one subword string obtained by speech recognition, includes a receiving step for receiving a retrieval key, an acquiring step for acquiring a result by retrieving retrieval data components based on a degree of correlation between the retrieval key received by the receiving step and each of the annotation data segments, a selecting step for selecting a data segment from the result acquired by the acquiring step in accordance with an instruction from a user, and a registering step for registering the retrieval key received by the receiving step in an annotation data segment associated with the data segment selected by the selecting step.

According to another aspect of the present invention, an apparatus for retrieving data from a database storing a plurality of retrieval data components including associated annotation data segments, each annotation data segment including at least one subword string obtained by speech recognition, includes a receiving unit configured to receive a retrieval key, an acquiring unit configured to acquire a result by retrieving retrieval data components based on a degree of correlation between the retrieval key received by the receiving unit and each of the annotation data segments, a selecting unit configured to select a data segment from the result acquired by the acquiring unit in accordance with an instruction from a user, and a registering unit configured to register the retrieval key received by the receiving unit in an annotation data segment associated with the selected data segment.

Therefore, the method and the apparatus according to the present invention can realize a high data-retrieval accuracy even when retrieval data includes an associated annotation created by speech recognition together with recognition errors.

Further features of the present invention will become apparent from the following description of exemplary embodiments with reference to the attached drawings.

### BRIEF DESCRIPTION OF THE DRAWINGS

FIG. 1A shows the functional structure of an apparatus for retrieving data and the flow of processing according to an exemplary embodiment of the present invention, and FIG. 1B shows an example of the structure of a retrieval data component.

FIG. 2 shows an example of a speech-recognized annotation data segment according to the exemplary embodiment.

FIG. 3 shows processing performed by a retrieval-key converting unit according to the exemplary embodiment.

FIG. 4 shows an example of phoneme matching processing performed by a retrieval unit according to the exemplary embodiment.

FIG. 5 shows an example of how a retrieval result is displayed on a display unit according to the exemplary embodiment.

FIG. 6 shows processing performed by an annotation registering unit according to the exemplary embodiment.

FIG. 7 shows the hardware configuration of the apparatus for retrieving data according to the exemplary embodiment.

FIG. 8 shows a modification of the speech-recognized annotation data segment according to the exemplary embodiment.

FIG. 9 shows an example of a subword graph according to the exemplary embodiment.

FIG. 10 shows an example of modified processing for adding a phoneme string, the processing being performed by the annotation registering unit, according to the exemplary embodiment.

### DESCRIPTION OF THE EMBODIMENTS

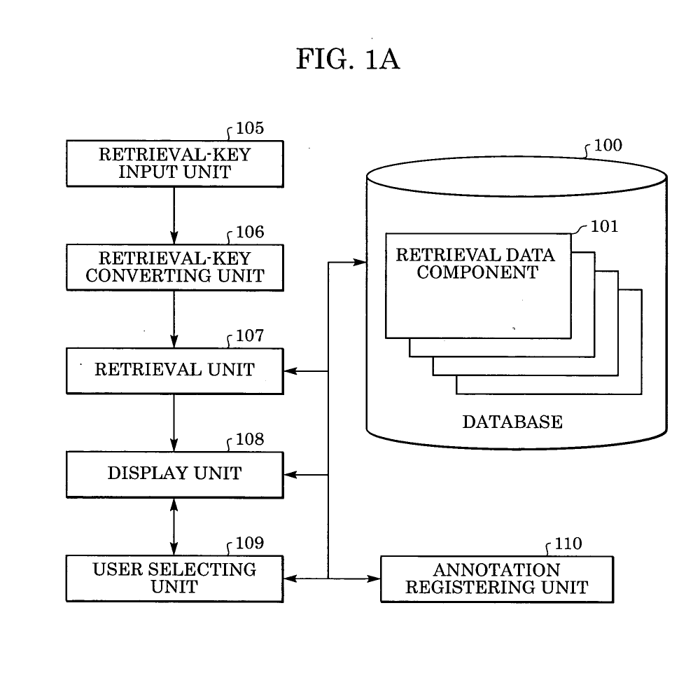

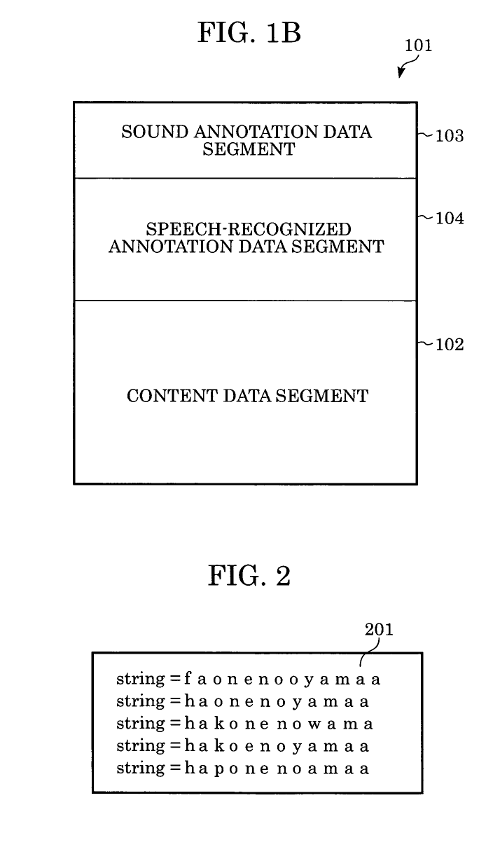

FIG. 1A shows the functional structure of an apparatus for retrieving data according to an exemplary embodiment of the present invention. A database 100 stores a plurality of retrieval data components 101 including images, documents, and the like as their content. Each of the retrieval data components 101 has, for example, the structure shown in FIG. 1B and includes a content data segment 102, such as an image, a document, or the like, a sound annotation data (sound memo data) segment 103 associated with the content data segment 102, and a speech-recognized annotation data segment 104 serving as an annotation data segment including a subword string, such as a phoneme string, a syllable string, a word string, and the like (for this embodiment, the phoneme string), obtained by performing the speech recognition on the sound annotation data segment 103.

A retrieval-key input unit 105 is used for inputting a retrieval key for retrieving a desired content data segment 102. A retrieval-key converting unit 106 is used for converting the retrieval key to a subword string having the same format as that of the speech-recognized annotation data segment 104 in order to perform matching for the retrieval key. A retrieval unit 107 is used for performing matching between the retrieval key and a plurality of speech-recognized annotation data segments 104 stored in the database 100, determining a correlation score with respect to each of the speech-recognized annotation data segments 104, and ranking a plurality of content data segments 102 associated with the speech-recognized annotation data segments 104. A display unit 108 is used for displaying the content data segments 102 ranked by the retrieval unit 107 in a ranked order. A user selecting unit 109 is used for selecting a user-desired data segment among the content data segments 102 displayed on the display unit 108. An annotation registering unit 110 is used for additionally registering the subword string to which the retrieval key is converted in the speech-recognized annotation data segment 104 associated with the data segment selected by the user selecting unit 109.

The functional structure of the apparatus for retrieving data according to the exemplary embodiment is generally as described above. Processing performed by this apparatus proceeds from the top of the blocks shown in FIG. 1A. In other words, FIG. 1A also shows the flow of the processing by the apparatus according to the exemplary embodiment. Next, the flow of the processing performed by the apparatus according to the exemplary embodiment is described below with reference to FIG. 1A.

As mentioned earlier, the retrieval data components 101 including images, documents, or the like as their content contains the corresponding sound annotation data segments 103 and the speech-recognized annotation data segments 104, which are created by performing the speech recognition on the sound annotation data segments 103 (see FIG. 1B). Each of the speech-recognized annotation data segments 104 may be created by a speech recognition unit of the apparatus or a speech recognition unit of another device, such as an image capturing camera. Since data retrieval in the present embodiment uses the speech-recognized annotation data segment 104, each of the sound annotation data segments 103 may become nonexistent after the speech-recognized annotation data segment 104 is created.

FIG. 2 shows an example of the speech-recognized annotation data segment 104. The speech-recognized annotation data segment 104 includes one or more speech-recognized phoneme strings 201 to which the sound annotation data segment 103 is subjected to speech recognition and conversion. For the speech-recognized phoneme strings 201, the top N speech-recognized phoneme strings (N is a positive integer) are consecutively arranged in accordance with the recognition score based on the likelihood.

A retrieval key input by a user to the retrieval-key input unit 105 is received. The received retrieval key is transferred to the retrieval-key converting unit 106, and the retrieval key is converted to a phoneme string having the same format as that of each of the speech-recognized phoneme strings 201.

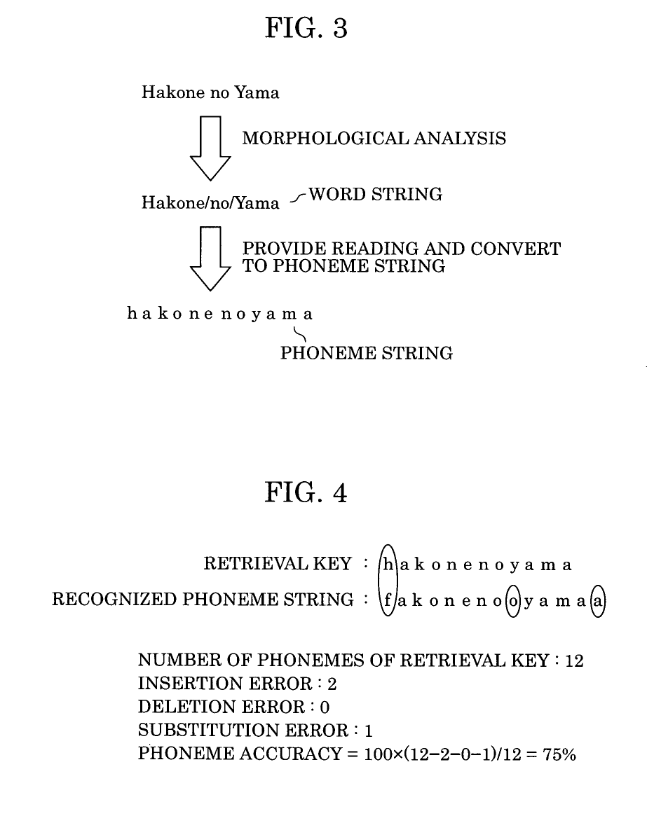

FIG. 3 shows how the retrieval key is converted to the phoneme string. The retrieval key “Hakone no Yama” is subjected to morphological analysis and divided into a word string. Then, the reading of the word string is provided, so that the phoneme string is obtained. A technique for performing morphological analysis and providing the reading may use a known natural language processing technology.

Then, the retrieval unit 107 performs phoneme matching between the phoneme string of the retrieval key and the speech-recognized annotation data segment 104 of each of the retrieval data components 101 and determines a phoneme accuracy indicating the degree of correlation between the retrieval key and each data segment. A matching technique may use a known dynamic programming (DP) matching method.

FIG. 4 shows how to determine the phoneme accuracy. When the number of correct phonemes, the number of insertion errors, the number of deletion errors, and the number of substitution errors are obtained by the DP matching method or the like, the phoneme accuracy is determined by, for example, the following formula:
Phoneme Accuracy={(the number of phonemes of retrieval key)−(the number of insertion errors)−(the number of deletion errors)−(the number of substitution errors)}×100/(the number of phonemes of retrieval key)

In FIG. 4, the number of insertion errors is two (“o” and “a”), and the number of substitution errors is one (“f” for “h”). Therefore, the phoneme accuracy is determined to be 75% (12-2-0-1)×100/12. Using the phoneme accuracy determined by such a manner as a score for retrieving, the content data segments 102 are ranked. Although the speech-recognized annotation data segment 104 shown in FIG. 2 includes the top N speech-recognized phoneme strings, the phoneme string with the highest phoneme accuracy is selected, as a result of performing phoneme matching on each of the top N speech-recognized phoneme strings. However, the present invention is not limited to this. A technique for multiplying the phoneme accuracy by a weighting factor according to the ranking and then determining the maximum value may be used. Alternatively, a technique for determining the total sum may be used.

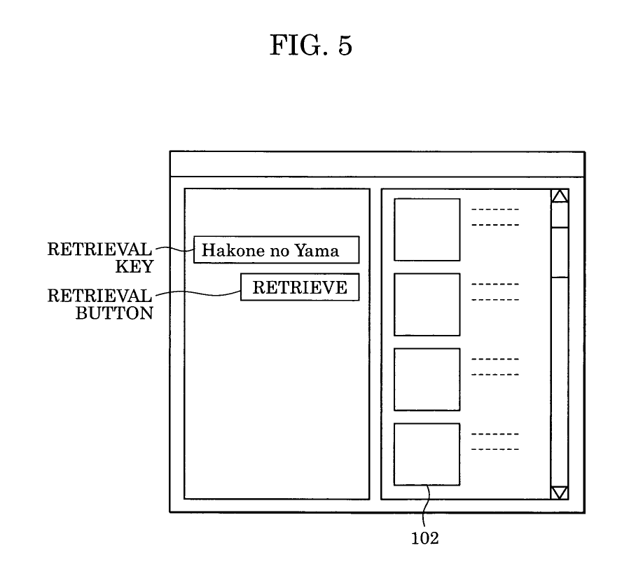

Next, data segments are displayed on the display unit 108 in the order of retrieval. FIG. 5 shows an example of how data segments (images in this example) are displayed on the display unit 108. In FIG. 5, when a retrieval key is input and a retrieval button is pressed in the left frame in a window, the retrieved content data segments 102 are displayed in the order of retrieval in the right frame in the window.

In this step, a user can select one or more content data segments from the data segments displayed. As previously described, a recognition error may occur in speech recognition, and therefore, a desired content data segment may not appear at a high ranking and may barely appear at a low ranking. In this embodiment, even if the desired content data segment is not retrieved at a high ranking, once a user selects the desired content data segment (image), the retrieval operation using the same retrieval key for the second and subsequent times can reliably retrieve the desired content data segment at a high ranking by the processing described below.

The user selecting unit 109 selects a data segment in accordance with the user's selecting operation. In response to this, the annotation registering unit 110 additionally registers the phoneme string to which the retrieval key is converted in the speech-recognized annotation data segment 104 associated with the selected data segment.

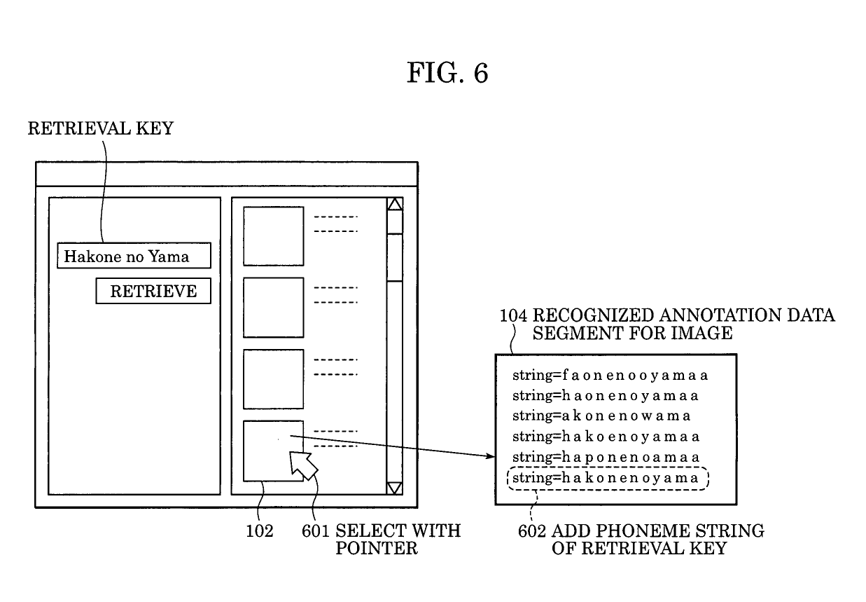

FIG. 6 shows this processing. In FIG. 6, a user selects one data segment with a pointer 601 among the data segments displayed. Selecting data may be performed by any method as long as an image can be specified. For example, an image clicked by the user may be selected without additional processing. Alternatively, the image clicked by the user may be selected after inquiring whether the user selects the clicked image and then receiving an instruction to select it from the user. A retrieval-key phoneme string 602 is the phoneme string to which the retrieval key is converted. The retrieval-key phoneme string 602 is additionally registered in the speech-recognized annotation data segment 104 associated with the selected content data segment. Therefore, in the case of the retrieval operation using the identical retrieval key for the second and subsequent times, the phoneme accuracy shown in FIG. 4 reaches 100%, and a desired data segment is retrieved at or near the first rank. Even when using partly the same retrieval key, the retrieval operation with partial matching technique realizes increased retrieval accuracy.

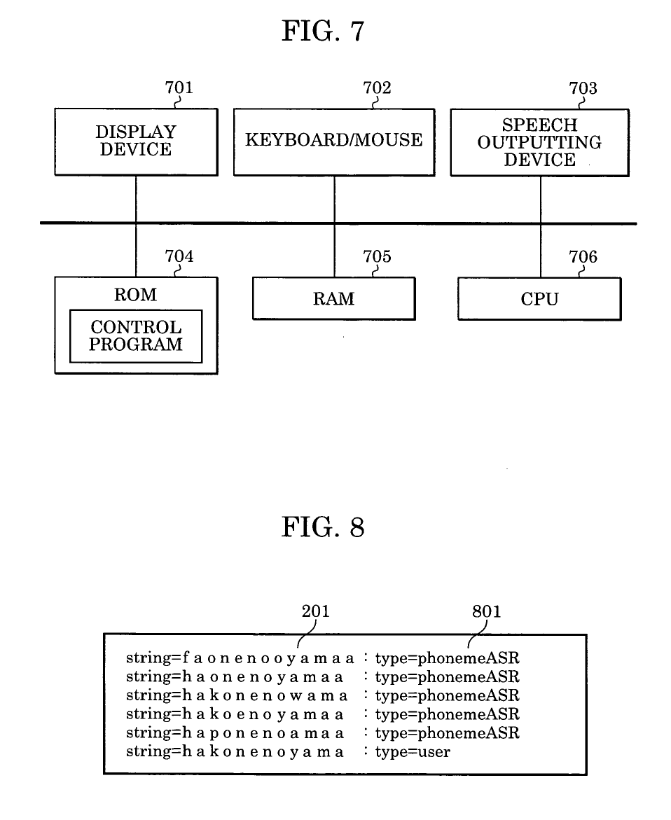

FIG. 7 shows the hardware configuration of the apparatus for retrieving data according to the exemplary embodiment. A display device 701 is used for displaying data segments, graphical user interfaces (GUIs), and the like. A keyboard/mouse 702 is used for inputting a retrieval key or pressing a GUI button. A speech outputting device 703 includes a speaker for outputting a sound, such as a sound annotation data segment, an alarm, and the like. A read-only memory (ROM) 704 stores the database 100 and a control program for realizing the method for retrieving data according to the exemplary embodiment. The database 100 and the control program may be stored in alternative external storage device, such as a hard disk. A random-access memory (RAM) 705 serves as a main storage and, in particular, temporally stores a program, data, or the like while the program of the method according to the exemplary embodiment is executed. A central processing unit (CPU) 706 controls the entire system of the apparatus. In particular, the CPU 706 executes the control program for realizing the method according to the exemplary embodiment.

In the exemplary embodiment described above, the score acquired by matching using phonemes as subwords is used. However, the present invention is not limited to this. For example, the score may be acquired by matching using syllables, in place of the phonemes, or by matching in units of words. A recognition likelihood determined by speech recognition may be added to this. The score may have a weight using the degree of similarity between phonemes (e.g., a high degree of similarity between “p” and “t”).

In the exemplary embodiment described above, the phoneme accuracy determined by exact matching of the phoneme string is used as the score for retrieving, as shown in FIG. 4. Alternatively, a partial matching technique with respect to a retrieval key may be used in retrieving by performing appropriate processing, such as suppressing a decrease in the score resulting from insertion error, or the like. For the embodiment described above, when the speech-recognized annotation data segment includes, for example, an attached annotation of “Hakone no Yama”, the partial matching technique allows retrieving using a retrieval key of “Hakone” and/or “Yama”.

The speech-recognized annotation data segment 104 in the embodiment described above is data consisting of the speech-recognized phoneme strings 201, as shown in FIG. 2. However, another mode is applicable. For example, each phoneme string may have an attribute to distinguish whether the phoneme string is the one created by speech recognition or the one added by the annotation registering unit 110 as the phoneme string of a retrieval key.

FIG. 8 shows the speech-recognized annotation data segment 104 according to this modification. The speech-recognized annotation data segment 104 includes one or more attributes 801 indicating the source of the respective phoneme strings. An attribute value of “phonemeASR” indicates the phoneme string created by speech recognition of the phoneme-string recognition type, whereas an attribute value of “user” indicates the phoneme string added by the annotation registering unit 110 when a user selects a data segment. Using the attributes 801 allows switching a displaying method according to a phoneme string used in retrieving or allows deleting a phoneme string additionally registered by the annotation registering unit 110. The attributes are not limited to this. The attribute value may be used to determine whether the speech recognition is of the phoneme string type or of the word string type.

The speech-recognized annotation data segment 104 in the embodiment described above is stored such that the top N recognized results are stored as subword strings (e.g. phoneme strings), as shown in FIG. 2. However, the present invention is not limited to this. Outputting a lattice composed of each subword (subword graph) and determining the phoneme accuracy for each path between the leading edge and the trailing edge of the lattice may be used.

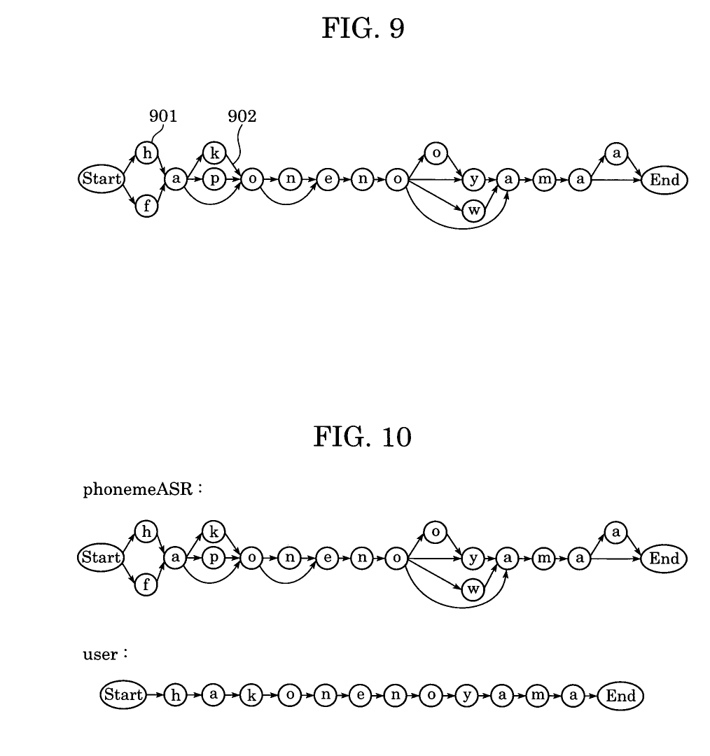

FIG. 9 shows an example of the subword graph. In FIG. 9, nodes 901 of the subword graph are formed on each phoneme. Links 902 are connected between the nodes 901, and represent the linkages between the phonemes. In general, links are assigned the likelihood for a speech recognition section between nodes connected by the links. Using the likelihood for a speech recognition section allows extracting the top N candidates of phoneme strings by a technique of the A* search. Then, matching between the retrieval key and each of the candidates yields the phoneme accuracy.

In this case, when a phoneme string is added by the annotation registering unit 110, a necessary node may be added to the subword graph shown in FIG. 9, or both the graph for the phoneme string created by speech recognition and a graph for the phoneme string added by the annotation registering unit 110 may be separately stored, as shown in FIG. 10. When the phoneme string added by the annotation registering unit 110 already exists in the paths of the subword graph shown in FIG. 9, the likelihood for a speech recognition section in the links 902 may be changed so that the paths including the added phoneme string are selected by the A* search.

The annotation registering unit 110 additionally registers the phoneme string of the retrieval key in the speech-recognized annotation data segment 104 in the embodiment described above. However, the present invention is not limited to this. For example, the N-th phoneme string among the top N speech-recognized phoneme strings (i.e., the phoneme string with the bottom recognition score among the speech-recognized annotation data segment 104) may be replaced with the phoneme string of the retrieval key.

In the embodiment described above, the phoneme string to which the retrieval key is converted is additionally registered in the speech-recognized annotation data segment 104 associated with a selected data segment. In this step, as a result of comparing the previously registered annotation data with the phoneme string to which the retrieval key is converted, when the degree of similarity is low, the phoneme string of the retrieval key may not be registered, and only when the degree of similarity is high, the phoneme string of the retrieval key may be additionally registered.

An exemplary embodiment of the present invention is described above. The present invention is applicable to a system including a plurality of devices and to an apparatus composed of a single device.

The present invention can be realized by supplying a software program for carrying out the functions of the embodiment described above directly or remotely to a system or an apparatus and reading and executing program code of the supplied program in the system or the apparatus. In this case, the program may be replaced with any form as long as it has the functions of the program.

Program code may be installed in a computer in order to realize the functional processing of the present invention by the computer. A storage medium stores the program.

In this case, the program may have any form, such as object code, a program executable by an interpreter, script data to be supplied to an operating system (OS), or some combination thereof, as long as it has the functions of the program.

Examples of storage media for supplying a program include a flexible disk, a hard disk, an optical disk, a magneto-optical disk (MO), a compact disc read-only memory (CD-ROM), a CD recordable (CD-R), a CD-Rewritable (CD-RW), magnetic tape, a nonvolatile memory card, a ROM, a digital versatile disk (DVD), including a DVD-ROM and DVD-R, and the like.

Examples of methods for supplying a program include connecting to a website on the Internet using a browser of a client computer and downloading a computer program or a compressed file of the program with an automatic installer from the website to a storage medium, such as a hard disk; and dividing program code constituting the program according to the present invention into a plurality of files and downloading each file from different websites. In other words, a World Wide Web (WWW) server may allow a program file for realizing the functional processing of the present invention by a computer to be downloaded to a plurality of users.

Encrypting a program according to the present invention, storing the encrypted program in storage media, such as CD-ROMs, distributing them to users, allowing a user who satisfies a predetermined condition to download information regarding a decryption key from a website over the Internet and to execute the encrypted program using the information regarding the key, thereby enabling the user to install the program in a computer is applicable.

Executing a read program by a computer can realize the functions of the embodiment described above. In addition, performing actual processing in part or in entirety by an operating system (OS) running on a computer in accordance with instructions of the program can realize the functions of the embodiment described above.

Moreover, a program read from a storage medium is written on a memory included in a feature expansion board inserted into a computer or in a feature expansion unit connected to the computer, and a CPU included in the feature expansion board or the feature expansion unit may perform actual processing in part or in entirety in accordance with instructions of the program, thereby realizing the functions of the embodiment described above.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-249014 filed Aug. 27, 2004, which is hereby incorporated by reference herein in its entirety.

What is claimed is:

1. A method for retrieving data from a database storing a plurality of retrieval data components including associated annotation data segments, each annotation data segment including at least one subword string obtained by speech recognition, the method comprising:
a receiving step for receiving a retrieval key;
an acquiring step for acquiring a result by retrieving retrieval data components based on a degree of correlation between the retrieval key received by the receiving step and each of the annotation data segments;
a selecting step for selecting a data segment from the result acquired by the acquiring step in accordance with an instruction from a user; and
a registering step for registering the retrieval key received by the receiving step in an annotation data segment associated with the data segment selected by the selecting step.

2. The method according to claim 1, further comprising:
a converting step for converting the retrieval key received by the receiving step to a subword string,
wherein the acquiring step acquires the result by retrieving the retrieval data components based on a degree of correlation between the subword string converted by the converting step and each of the subword strings included in the annotation data segments.

3. The method according to claim 2, wherein the registering step additionally registers the subword string converted by the converting step.

4. The method according to claim 3, wherein the registering step registers the subword string converted by the converting step by substituting the subword string converted by the converting step for a subword string having the bottom recognition score among the plurality of subword strings, in place of additionally registering the subword string converted by the converting step.

5. The method according to claim 1, wherein each of the annotation data segments includes a plurality of subword strings selected according to respective recognition scores after the speech recognition.

6. The method according to claim 5, wherein each of the annotation data segments includes a lattice structure representing the plurality of subword strings.

7. The method according to claim 6, wherein each of the annotation data segments includes identification information corresponding to each of the plurality of subword strings, the identification information functioning to distinguish whether each of the plurality of subword strings is the subword string obtained by the speech recognition or the subword string registered by the registering step.

8. The method according to claim 5, wherein each of the annotation data segments includes identification information corresponding to each of the plurality of subword strings, the identification information functioning to distinguish whether each of the plurality of subword strings is the subword string obtained by the speech recognition or the subword string registered by the registering step.

9. A control program for making a computer perform the method according to claim 1.

10. An apparatus for retrieving data from a database storing a plurality of retrieval data components including associated annotation data segments, each annotation data segment including at least one subword string obtained by speech recognition, the apparatus comprising:
a receiving unit configured to receive a retrieval key;
an acquiring unit configured to acquire a result by retrieving retrieval data components based on a degree of correlation between the retrieval key received by the receiving unit and each of the annotation data segments;
a selecting unit configured to select a data segment from the result acquired by the acquiring unit in accordance with an instruction from a user; and
a registering unit configured to register the retrieval key received by the receiving unit in an annotation data segment associated with the selected data segment.
